(19) United States
(12) Patent Application Publication
(10) Pub. No.: US 2015/0026814 A1
(43) Pub. Date: Jan. 22, 2015

(54) INVISIBLE INTERFACE FOR MANAGING SECURED DATA TRANSACTIONS

(71) Applicant: International Business Machines Corporation, Armonk, NY (US)

(72) Inventors: Sasha P. Caskey, New York, NY (US); Jian Ni, Ossining, NY (US); Andrzej Sakrajda, Briarcliff Manor, NY (US); Hui Wan, White Plains, NY (US); Cheng Wu, Mount Kisco, NY (US)

(73) Assignee: International Business Machines Corporation, Armonk, NY (US)

(21) Appl. No.: 13/947,717

(22) Filed: Jul. 22, 2013

(51) Int. Cl. G06F 21/60

(52) U.S. Cl. CPC G06F 21/60
USPC 726/26

(57) ABSTRACT

In an exemplary embodiment, a computer-implemented method for secure data transactions includes storing, by a processing device, personal data on a wearable data storage applicable to a body of a user. The wearable data storage is rendered invisible.

### BACKGROUND

Embodiments of this disclosure relate generally to secured data transactions and, more specifically, to providing an invisible interface that is worn by a user for managing secured data transactions.

The electronic data transaction market is currently filled with many types of credit cards, debit cards, identification cards, stored value cards, insurance cards, and loyalty cards. The increasing quantity of the cards makes organization and transportation of the cards increasingly difficult. Historically, cards have been embodied in tangible media, such as plastic, and thus are susceptible to loss, theft, or simply being left at home when needed. With the continued growth in card-based transactional offerings provided to consumers, many consumers are faced with the burdensome task of organizing, managing, tracking, transporting, and storing all their credit, debit, identification, stored-value, insurance, loyalty, and other types of merchant, vendor, and provider issued cards.

There is also an increasing demand for identification in the form of identification cards that are based on electronic data. A similar challenge exists here as with credit cards, because people have the same burden of managing, securely carrying, and delivering their personal identification information.

### BRIEF SUMMARY

In one embodiment of this disclosure, a computer-implemented method for secure data transactions includes storing, by a processing device, personal data on a wearable data storage applicable to a body of a user. The wearable data storage is rendered invisible.

In another embodiment, a system for secure data transactions includes an invisible data storage interface configured to store personal data of a user, the invisible data storage interface being wearable on a body of the user.

In yet another embodiment, a computer program product includes a computer readable storage medium having computer readable program code embodied thereon. The computer readable program code is executable by a processor to perform a method. The method includes storing personal data on a wearable data storage applicable to a body of a user. The wearable data storage is rendered invisible.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 depicts a block diagram of a computer system according to an exemplary embodiment of this disclosure;

FIG. 2 depicts a flow diagram of a method for providing an invisible interface that is worn by a user for managing secured data transactions according to an exemplary embodiment;

FIG. 3 depicts a block diagram of a wearable storage device acting as the invisible interface, according to an exemplary embodiment; and

FIG. 4 depicts a flow diagram of a use case for the invisible interface according to an exemplary embodiment.

### DETAILED DESCRIPTION

Embodiments disclosed herein are directed to providing an invisible interface that is worn by a user for managing secured data transactions. An aspect of some embodiments includes applying a wearable data storage onto a body of a user. In some cases, the wearable data storage may be made of invisible materials or may have an applied invisible cloaking layer. Personal data of the user may be stored on the wearable data storage. The wearable data storage may be rendered invisible.

Many consumers are faced with the burdensome task of organizing, managing, transporting, and storing all of their credit, debit, identification, stored-value, insurance, loyalty, and other types of merchant, vendor, and provider issued cards. Particularly, there are many locations where it may be a burden to carry multiple cards, such as at amusement parks, cruise trips, or during outdoor exercises. Moreover, the cards may be exposed to theft if not properly secured. Despite the burden, a consumer may be required to produce identification or authentication cards at these locations to perform data transactions. Embodiments disclosed herein provide an invisible interface that is worn by a user for conveniently managing secured data transactions such as for identification or authentication. It will be understood that the term “invisible,” as used herein, can but need not refer to a material's being completely imperceptible by the human eye at all times, but may instead refer to imperceptibility at some viewing angles or some conditions.

Conventional watermarks to indicate authenticity include both physical and digital watermarks. A visible, physical watermark is made by impressing a water-coated metal stamp. These watermarks, however, are prone to fraud, and the typical watermark may last only twenty-four hours and may be easily damaged. Further, physical watermarks are incapable of carrying embedded data streams. Digital watermarks are electronic versions of their traditional counterparts. Digital watermarking is a means for embedding data into digital and analog content (e.g., video, audio, and images) to identify an owner. Conventional digital watermarking software applications allow individuals to embed watermarks (e.g., data streams) within image, audio, and video files. Digital watermarks can only be embedded in digital materials such as video, audio, and images, which require physical media.

Conventional key fobs may also be used to indicate authenticity, but they too are electronic devices. Instead of carrying a physical magnetic card, a user would have to carry a physical electronic device. It may not be practical for a user to carry an electronic device for some activities, and a user may easily lose the electronic device.

Accordingly, some embodiments disclosed herein are systems, methods, and computer program products for storing personal data, such as identification and authentication information, on a human body securely and invisibly. Some embodiments provide a coating layer or data strip on which computer-aided information and computer-readable information may be embedded. The coating layer or data strip may be invisible or translucent and may be disposed onto human skin.

The coating layer or data strip may verify the authenticity or integrity of a carrier signal or show the identity of its owners. The date stored in the coating layer or data strip may be undetectable by the human eye and ear, but may be detectable and readable via a computer based device. The personal data that is stored in the coating layer or data strip may be read by a scanner (e.g., laser scanner, magnetic reader) and may implement various password controls in some embodiments.

The personal data embedded on the coating layer or data strip may be used to support credit, debit, identification, stored-value, insurance, loyalty, or other types of merchant, vendor, or provider issued cards. The personal data may be automatically decomposed or destroyed over time or after a preset valid time is expired.

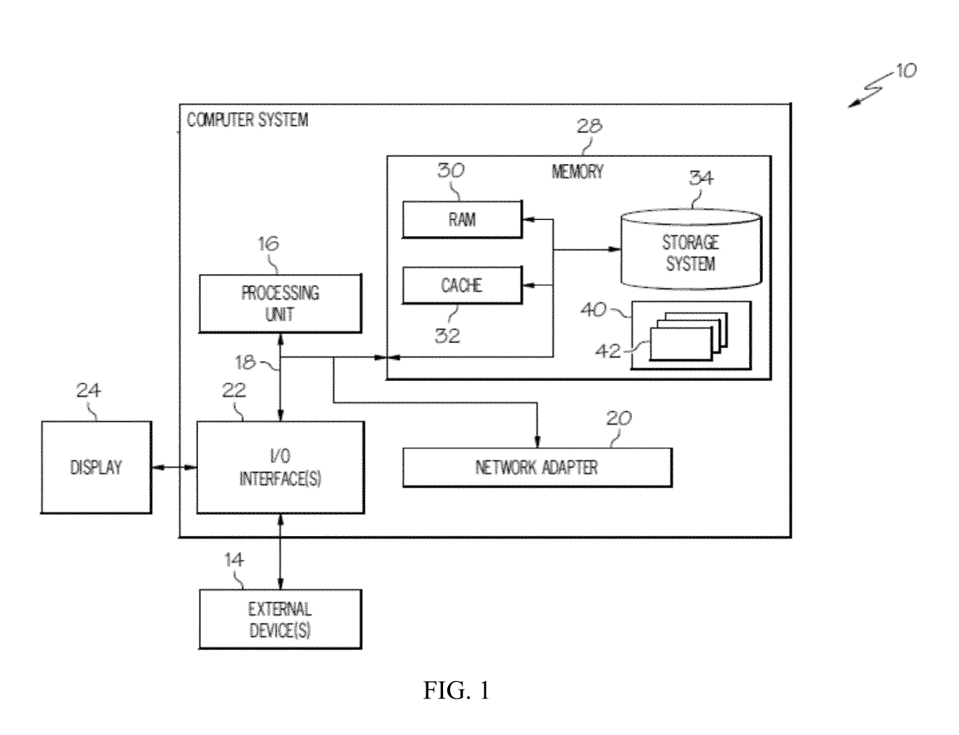

Referring now to FIG. 1, a block diagram of an exemplary computer system 10 suitable for providing an interface worn by a user for managing secured data transactions, or for reading such an interface, is shown. Computer system 10 is only one example of a computer system and is not intended to suggest any limitation as to the scope of use or functionality of embodiments described herein.

Computer system 10 may be operational with numerous other general purpose or special purpose computing system environments or configurations. Examples of well-known computing systems, environments, and/or configurations that may be suitable for use with computer system 10 include, but are not limited to, personal computer systems, server computer systems, thin clients, thick clients, mobile telephones and other mobile devices, card readers, handheld or laptop devices, multiprocessor systems, microprocessor-based systems, set top boxes, programmable consumer electronics, network PCs, minicomputer systems, mainframe computer systems, and distributed cloud computing environments that include the above systems and devices, or the like.

Computer system 10 may be described in the general context of computer-executable instructions, such as program modules, being executed by the computer system 10. Generally, program modules may include routines, programs, objects, components, logic, data structures, and so on that perform particular tasks or implement particular abstract data types. Computer system 10 may be practiced in distributed cloud computing environments where tasks are performed by remote processing devices that are linked through a communications network. In a distributed computing environment, program modules may be located in both local and remote computer system storage media, including memory storage devices.

As shown in FIG. 1, computer system 10 is shown in the form of a general-purpose computing device. The components of the computer system 10 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system 10 may include a variety of computer system readable media. Such media may be any available media that is accessible by computer system/server 10, and it includes both volatile and non-volatile media, removable and non-removable media.

System memory 28 can include computer system readable media in the form of volatile memory, such as random access memory (RAM) 30 and/or cache memory 32. Computer system 10 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the disclosure.

Program/utility 40, having a set of at least one program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system 10 may also communicate with one or more external devices 14 such as a keyboard, a pointing device, a display 24, etc.; one or more devices that enable a user to interact with computer system/server 10; and/or any devices (e.g., network card, modem, etc.) that enable computer system/server 10 to communicate with one or more other computing devices. Such communication can occur via Input/Output (I/O) interfaces 22. Still yet, computer system 10 can communicate with one or more networks such as a local area network (LAN), a general wide area network (WAN), and/or a public network (e.g., the Internet) via network adapter 20. As depicted, network adapter 20 communicates with the other components of computer system 10 via bus 18.

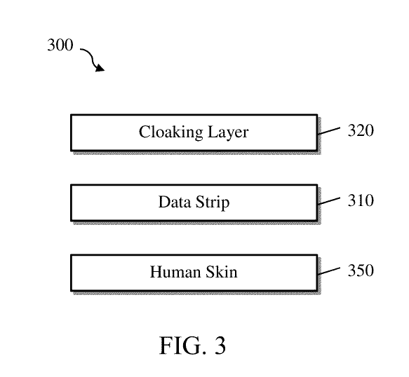

In some exemplary embodiments, the computer system 10 may communication with a wearable data storage device 300 (FIG. 3) via the network adapter, over a wireless connection. Using that wireless connection, the computer system 10 may transfer to, and receive data from, the wearable data storage device 300. Such data may be entered by an administrator or other user through an external device 14, such as a keyboard or pointing device.

It should be understood that although not shown, other hardware and/or software components could be used in conjunction with computer system 10. Examples include, but are not limited to: microcode, device drivers, redundant processing units, external disk drive arrays, RAID systems, tape drives, and data archival storage systems, etc.

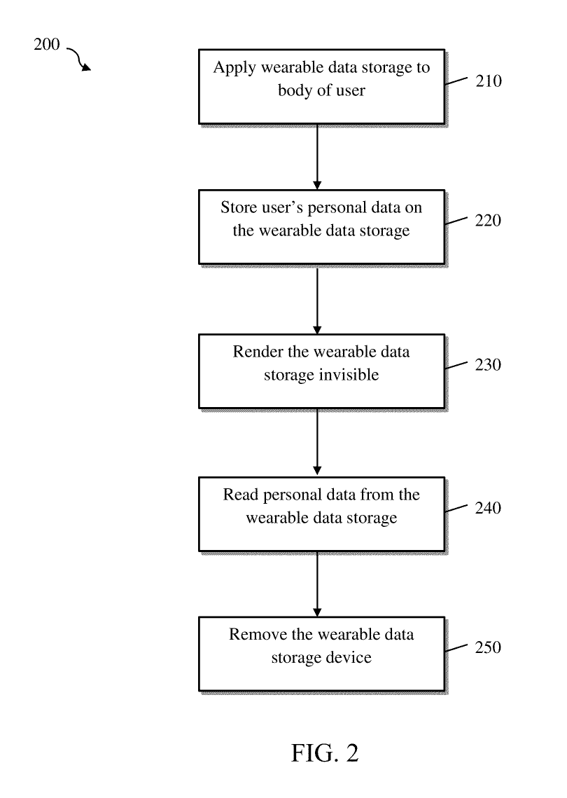

With reference to FIG. 2, a method 200 performed by an exemplary embodiment of a processing device 16 of computer system 10 is generally shown. As shown in FIG. 2, the process 200 provides an invisible interface that is worn by a user for managing secured data transactions according to an embodiment.

At block 210, a wearable data storage is applied onto a body of a user. According to an embodiment, the wearable data storage may be disposed on the exterior surface of the skin of the user (e.g., hands, arms, legs).

At block 220, the personal data of the user may be stored on the wearable data storage. According to an embodiment, the personal data of the user may include identification information, authentication information, authorization information, transactional information, and/or the like.

At block 230, the wearable data storage is rendered invisible according to an embodiment. The wearable data storage may include a coating disposed on the skin of the user. According to one embodiment, the coating may further include a data strip for storing the personal data disposed on the coating and a cloaking layer disposed on the data strip to render the data strip invisible. The data strip may be a magnetic strip or a silicon layer according to an embodiment. According to another embodiment, the coating may include only an invisible cloaking layer for storing the user's personal data. In other words, according to an embodiment a data strip may either be covered by or built-in with an invisible cloaking layer that sticks to human skin.

According to an embodiment, the wearable data storage may be rendered invisible by using a coating of reflective metal to make the wearable data storage less visible. In nanoscale physics, it is known that the reflected light from the two materials may cancel each other to make the wearable data storage invisible. According to an embodiment, plasmonic cloaking may render the wearable data storage invisible. The scattered light from the reflective metal and the silicon of the wearable data storage may cancel each other out with plasmonic cloaking. By creating a dipole in the metal that is equal in strength but opposite in sign to the dipole in the silicon, when equally strong positive and negative dipoles meet, they cancel each other out and the wearable data storage becomes invisible.

According to an embodiment, a plasmonic cloaking material (e.g., gold, aluminum, copper, etc.) may be used to cover the data strip, such as a special semiconductor strip, which may be painted or otherwise disposed on a human body. According to another embodiment, a built-in silicon device layer may be created with cloaking materials to carry the personal data. The coating layer may not only allow light to reach the strip so the data stored on the data strip can be read out, but may also make the data strip invisible. The data strip, as well as its outside invisible cloaking, can be painted on or installed on-demand, and the expiration date on the data strip may be controllable through user input. Therefore, the data strip can be covered under or built inside a coating layer and the coating layer may render the strip invisible while allowing light (e.g., a laser beam) to reach the strip so the data stored on the strip can be read by a scanning device.

Plasmonic cloaking is effective across much of the visible spectrum of light and that the effect works regardless of the angle of incoming light or the shape and placement of the metal-covered nanowires in the wearable data storage device. According to an embodiment, a cylinder is built using high temperature superconductor material, which is refrigerated with liquid nitrogen and covered in a layer of iron, nickel and chrome. This formula may be used to create an invisibility cloak according to an embodiment. The plasmonic cloaking metal layer may serve the dual functions of making the data strip invisible and protecting the data strip (e.g., waterproofing).

At block 240, the personal data stored on the wearable data storage may be read using a scanner according to an embodiment. The personal data may be selectively rendered to be unreadable by designated people and/or at designated locations or times. According to an embodiment, the personal data may be encrypted or may only be accessible with a preset password. The password need not be limited to a traditional string of typed characters. Rather, when accessing the stored data, the password may be provided through various means, such as by voice, fingerprint, or face recognition.

At block 250, the wearable storage device may be removed or the personal data may be removed from the wearable data storage. According to another embodiment, the wearable data storage may be set to decompose or to be destroyed after a preset time has expired, or the wearable storage may decompose naturally over time.

FIG. 3 is a block diagram of a wearable storage device 300 acting as an invisible interface, according to an exemplary embodiment. As shown in FIG. 3, the wearable storage device 300 may include a data strip 310 and a cloaking layer 320, which may be combined into a single layer, and which may both be positioned on human skin 350. The data strip 310 may have embedded on it the personal data meant to be stored by the wearable storage device 310. The cloaking layer 320 may render the data strip 310 invisible, translucent, or nearly so. In some embodiments, both the data strip 310 and the cloaking layer 320 may be flexible, so as to flex and move along with the human skin to which they are attached.

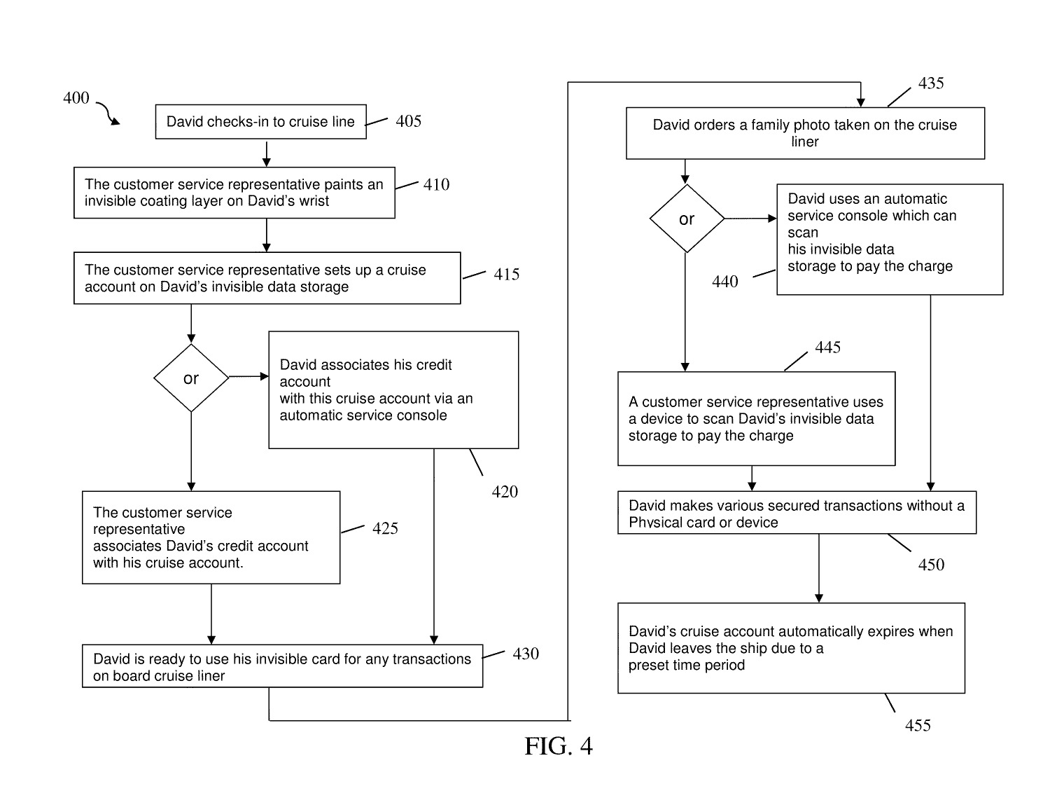

FIG. 4 depicts a flow diagram of a use case 400 for the invisible interface according to an embodiment. In this use case 400, David uses the invisible interface of an embodiment while on a cruise liner with his family.

At block 405, David approaches a check-in desk on the cruise liner according to this use case 400. A customer service representative may then install or paint the invisible data storage of an embodiment on David's wrist, as shown in block 410. At block 415, the customer service representative may set up a cruise account on David's invisible data storage. At this point, David may associate his credit account with this cruise account by himself via an automatic service console, as shown in block 420. David may also set up a temporary password and expiration time for the cruise account. Alternatively, the customer service representative may associate David's credit account with the cruise account, as shown in block 425. The customer service representative may also set up a temporary password for the cruise account and an expiration time for David's cruise account.

David is now ready to use his invisible data storage for any data transaction onboard the cruise liner, as shown in block 430. A transaction may include automatically checking his credit and/or credit account via a scanner. According to this use case 400, David may want to order a family photo taken on the cruise liner, as shown in block 435. David may use an automatic service console that can scan his invisible data storage for credit authorization to pay the charge, as shown in block 440. This may require David to enter his password according to an embodiment. Alternatively, the customer service representation may use a device to scan David's invisible data storage for credit authorization to pay the charge, as shown in block 445. This also may require David to enter his password according to an embodiment. Accordingly, David may have many secured transactions without a physical card or device according to an embodiment, as shown in block 450.

As shown in block 455, David's cruise account may automatically expire when David leaves the ship due to the preset expiration time period. According to an embodiment, the customer service representative may deactivate David's account at any time. When David's account expires the cloaking layer which hosts the invisible data storage will decompose and may be washed away with water according to an embodiment.

Technical effects and benefits include the ability to carry personal data, such as identification and authentication data, on an invisible data storage disposed on the human body to ease the burden of transporting multiple, physical forms of identification and authentication (e.g., credit cards, driver's license, etc.). Also, embodiments provide extra security of credit cards or identification cards due to the invisibility of the data storage. Embodiments disclosed herein may be performed without active participation of the authenticated user. Moreover, the user will always have personal information with him at all times and others cannot detect this information and where it is stored.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

Further, as will be appreciated by one skilled in the art, aspects of the present disclosure may be embodied as a system, method, or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented method such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A computer-implemented method for secure data transactions, comprising:
storing, by a processing device, personal data on a wearable data storage applicable to a body of a user;
wherein the wearable data storage is rendered invisible.

2. The computer-implemented method of claim 1, wherein the wearable data storage is attachable to an exterior skin of the user.

3. The computer-implemented method of claim 1, further comprising reading the personal data stored on the wearable data storage using a scanner.

4. The computer-implemented method of claim 1, wherein the personal data comprises a selected one or more of identification information, authentication information, authorization information, and transactional information.

5. The computer-implemented method of claim 1, further comprising password-protecting the personal data on the wearable data storage.

6. The computer-implemented method of claim 1, further comprising removing the personal data from the wearable data storage.

7. The computer-implemented method of claim 1, wherein the wearable data storage automatically decomposes after a preset time has expired.

8. The computer-implemented method of claim 1, further comprising selectively rendering the personal data unreadable.

9. The computer-implemented method of claim 8, wherein the rendering the personal data unreadable further comprises a selected one of encrypting the personal data and encoding a password to access the personal data.

10. The computer-implemented method of claim 1, wherein the wearable data storage is waterproof

11. A system for secure data transactions, comprising:
an invisible data storage interface configured to store personal data of a user, the invisible data storage interface being wearable on a body of the user.

12. The system of claim 11, wherein the invisible data storage interface comprises a coating disposed on the skin of the user, the coating further comprising:
a data strip configured to store the personal data disposed on the coating; and
a cloaking layer positionable on the data strip to render the data strip invisible.

13. The system of claim 11, wherein the invisible data storage interface comprises a coating disposed on the skin of the user, the coating further comprising an invisible cloaking layer for storing the personal data.

14. The system of claim 12, wherein the data strip is a magnetic strip.

15. The system of claim 12, wherein the data strip is a silicon layer.

16. A computer program product comprising a computer readable storage medium having computer readable program code embodied thereon, the computer readable program code executable by a processor to perform a method comprising:
storing personal data on a wearable data storage applicable to a body of a user;
wherein the wearable data storage is rendered invisible.

17. The computer program product of claim 16, the method further comprising reading the personal data stored on the wearable data storage using a scanner.

18. The computer program product of claim 16, wherein the personal data comprises a selected one or more of identification information, authentication information, authorization information, and transactional information.

19. The computer program product of claim 16, the method further comprising automatically decomposing the wearable data storage after a preset time has expired.

20. The computer program product of claim 16, the method further comprising selectively rendering the personal data unreadable.
